(19) United States
(12) Patent Application Publication
(10) Pub. No.: US 2021/0057937 A1
(43) Pub. Date: Feb. 25, 2021

(54) MODULAR CHARGING DEVICES AND METHODS FOR USING THEM

(71) Applicant: GLOBAL TRADE & TECHNOLOGY CORP., Lake Forest, CA (US)

(72) Inventors: Ammar Adra, Ladera Ranch, CA (US); Hao Wang, Shenzhen (CN)

(21) Appl. No.: 16/997,827

(22) Filed: Aug. 19, 2020

Related U.S. Application Data
(60) Provisional application No. 62/888,970, filed on Aug. 19, 2019.

(51) Int. Cl. H02J 50/40; H02J 50/10; H02J 50/90; H02J 50/00

(52) U.S. Cl. CPC H02J 50/40; H02J 50/005; H02J 50/90; H02J 50/10

(57) ABSTRACT

Modular charging devices and methods for using them are provided for simultaneously charging multiple electronic devices. Each charger may include at least one connector including a magnet array and an inductive charging circuit. A first charger may be connected to a power source, and a second charger may be placed adjacent a first side surface of the first charger and a second side surface of the second charger may be oriented towards the first side surface. If connectors of the chargers are compatible, magnet arrays may attract one another to automatically connect the chargers to deliver electrical energy from the power source to both inductive charging circuits. If the connectors are incompatible, the magnet arrays may repel one another to prevent connecting the chargers.

### RELATED APPLICATION DATA

The present application claims benefit of co-pending U.S. provisional application Ser. No. 62/888,970, filed Aug. 19, 2019, the entire disclosure of which is expressly incorporated by reference herein.

### FIELD OF THE INVENTION

The present invention relates to devices for charging electronic devices, and, more particularly, to charging devices for inductively charging electronic devices, such as cellphones, tablets, wireless headphones, watches, GPS devices, and the like, and to methods for using such charging devices.

### BACKGROUND

Portable electronic devices, such as cellphones, tablets, wireless headphones, watches, GPS devices, and the like, have become ubiquitous in modern society. An individual may have multiple devices, each of which must have their batteries routinely recharged to keep them operational. Many of these devices have their own charging cables, which must be kept and plugged into available outlets to recharge the devices, which can be difficult, particularly when only a single electrical outlet is available to an individual with multiple devices.

More recently, many electronic devices include inductive charging capabilities, e.g., including internal inductive coils or circuits coupled to their batteries, such that the electronic devices may be placed on an inductive charger to recharge their batteries without connecting a cable. However, each of these chargers themselves include cables that must be plugged into available outlets to power the charging devices. Although inductive chargers can be more convenient, given that an electronic device can simply be placed on the charger without requiring connecting a cable, an individual must still keep a power cable for each of their inductive chargers. Thus, an individual with multiple chargers must still keep multiple power cables, which, along with other cables for the electronic devices, may be difficult to organize. Further, an individual with multiple chargers may still need multiple electrical outlets if they want to charge multiple devices simultaneously.

Therefore, charging devices that facilitate charging multiple electronic devices simultaneously would be useful.

### SUMMARY

The present invention is directed to charging devices for charging electronic devices, and, more particularly, to devices for inductively charging multiple electronic devices simultaneously, such as cellphones, tablets, wireless headphones, watches, GPS devices, and the like, and methods for using them.

In accordance with one embodiment, a device is provided for charging electronic devices that includes a housing including an upper surface upon which an electronic device may be placed, and a plurality of side surfaces; an inductive charging circuit within the housing for inductively charging an electronic device placed on the upper surface; a power connector or power cable on the housing for connecting to a power source; a first connector and first magnet array on a first side surface of the plurality of side surfaces; and a power distribution circuit within the housing coupling the power connector or power cable to the inductive charging circuit and the first connector to simultaneously provide electrical energy to the inductive charging circuit and the first connector when the power connector or power cable is connected to a power source, wherein the first magnet array is configured to attract a magnet array from a second charging device having a compatible connector such that the compatible connector is automatically coupled to the first connector when the second charging device is positioned adjacent the first side surface.

Further, multiple charging devices may be provided that may be coupled together to allow multiple electronic devices to be inductively charged simultaneously. For example, a user can couple three or four charging devices together, e.g., in a row, with any one of them connected to a power source, and then an electronic device may be placed on each of the charging devices to charge them simultaneously. It will be appreciated that any combination of inductively chargeable devices may be placed on the resulting set of coupled charging devices, e.g., any combination of one or more cellphones, tablets, wireless headphones, watches, GPS devices, and the like.

In accordance with another embodiment, a device is provided for charging electronic devices that includes a housing including an upper surface upon which an electronic device may be placed, and a plurality of side surfaces; an inductive charging circuit within the housing for inductively charging an electronic device placed on the upper surface; a power connector or power cable on the housing for connecting to a power source; a first male connector and first magnet array on a first side surface; a second female connector and second magnet array on a second side surface; and a power distribution circuit within the housing coupled to the power connector or power cable, the inductive charging circuit, the first male connector, and the second female connector to simultaneously provide electrical energy to the inductive charging circuit, the first male connector, and the second female connector when the power connector or power cable is connected to a power source.

In accordance with still another embodiment, a device is provided for charging electronic devices that includes a housing including an upper surface, a plurality of side surfaces, and a lower surface opposite the upper surface; a mount received in a recess in the housing extending from the upper surface towards the lower surface, an inductive charging circuit carried by the mount for inductively charging an electronic device placed adjacent the charging circuit, the mount movable out of the recess from a flat position to a raised position to position the charging circuit laterally relative to the upper surface of the housing; a power connector or power cord on the housing for connecting to a power source; a first connector and a first magnet array on a first side surface of the plurality of side surfaces; and a power distribution circuit within the housing coupling the power connector to the inductive charging circuit and the first connector to simultaneously provide electrical energy to the inductive charging circuit and the first connector when a power connector or power cable is connected to the power source, wherein the first magnet array is configured to attract a magnet array from a second charging device having a compatible connector such that the compatible connector is automatically coupled to the first connector when the second charging device is positioned adjacent the first side surface.

In accordance with yet another embodiment, a method is provided for simultaneously charging multiple electronic devices that includes connecting a first charging device to a power source, the first charging device including a first connector on a first side surface and a first inductive charging circuit coupled to the power source via a power distribution circuit, the first charging device further comprising a first magnet array on the first side surface adjacent the first connector; placing a second charging device adjacent the first side surface, the second charging device including a second connector on a second side surface coupled to a second inductive charging circuit, the second charging device further comprising a second magnet array on the second side surface adjacent the second connector; and orienting the second side surface towards the first side surface such that, if the first and second connectors are compatible, the first and second magnet arrays attract one another to connect the second connector to the first connector, e.g., automatically, to deliver electrical energy from the power source to the second inductive charging circuit, and, if the first and second connectors are incompatible, the first and second magnet arrays repel one another to prevent connecting the second connector to the first connector.

In accordance with still another embodiment, a method is provided for simultaneously charging multiple electronic devices, each charging device comprising a housing including an upper surface, an inductive charging circuit for inductively charging an electronic device placed adjacent the upper surface; a first male connector and a first magnet array on a first side surface of the housing; a second female connector and a second magnet array on a second side surface of the housing; and a power distribution circuit within the housing to distribute electrical energy in parallel to the inductive charging circuit, the first male connector, and the second female connector, the method including connecting at least one of the charging devices to a power source, and positioning male and female connectors of adjacent charging devices adjacent one another such that the first and second magnetic arrays attract the male and female connectors of the adjacent charging devices to automatically connect the adjacent male and female connectors, thereby coupling the power distribution circuits together to simultaneously deliver electrical energy from the power source to each inductive charging circuit.

Other aspects and features of the present invention will become apparent from consideration of the following description taken in conjunction with the accompanying drawings.

### BRIEF DESCRIPTION OF THE DRAWINGS

The drawings illustrate exemplary embodiments of the invention, in which:

FIG. 1 is a perspective view of an exemplary embodiment of a modular charging device.

FIGS. 2A-2F are top, side, and bottom views of the charging device of FIG. 1.

FIG. 3A is a top view showing three modular charging devices connected together.

FIG. 3B is a schematic showing three modular charging devices, such as those shown in FIG. 3A, being connected together to simultaneously inductively charge multiple electronic devices.

FIGS. 4A and 4B are details showing an exemplary embodiment of a female pin connector and FIGS. 5A and 5B are details showing an exemplary embodiment of a corresponding male pin connector for connecting charging devices to one another.

FIGS. 6A and 6B are perspective views of another embodiment of a modular charging device including a charging element in flat and raised positions, respectively.

FIGS. 7A-7F are top, side, and bottom views of the charging device of FIGS. 6A and 6B.

### DETAILED DESCRIPTION OF THE EXEMPLARY EMBODIMENTS

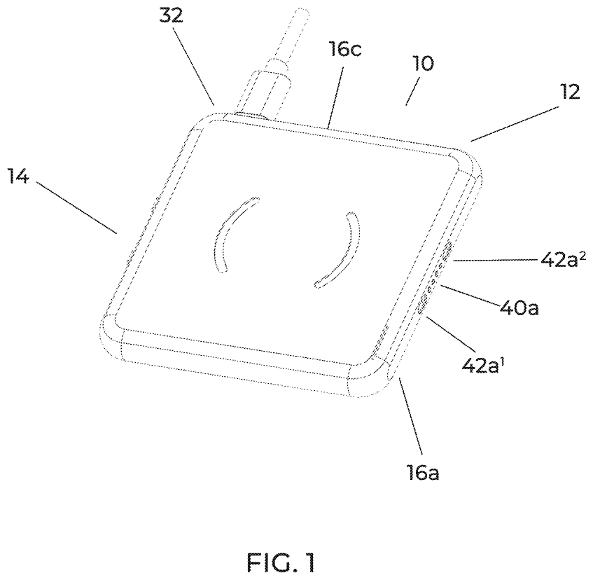

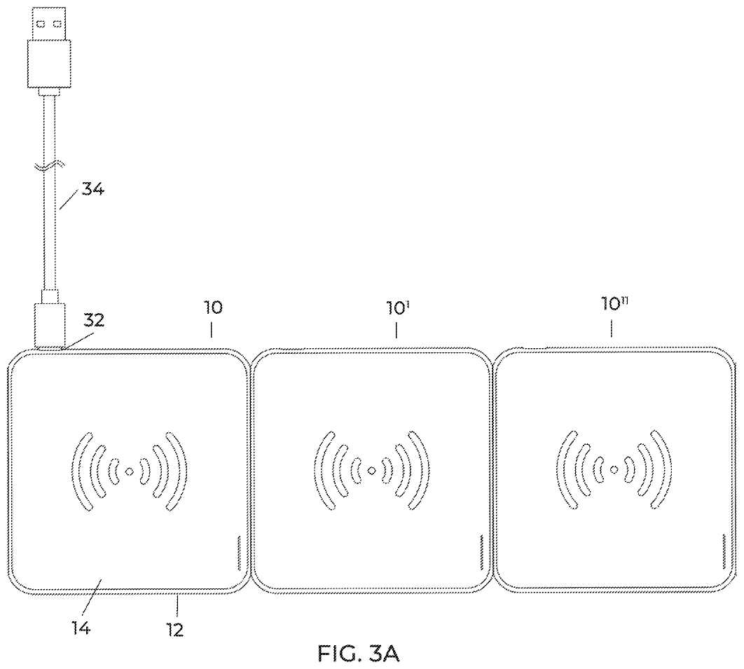

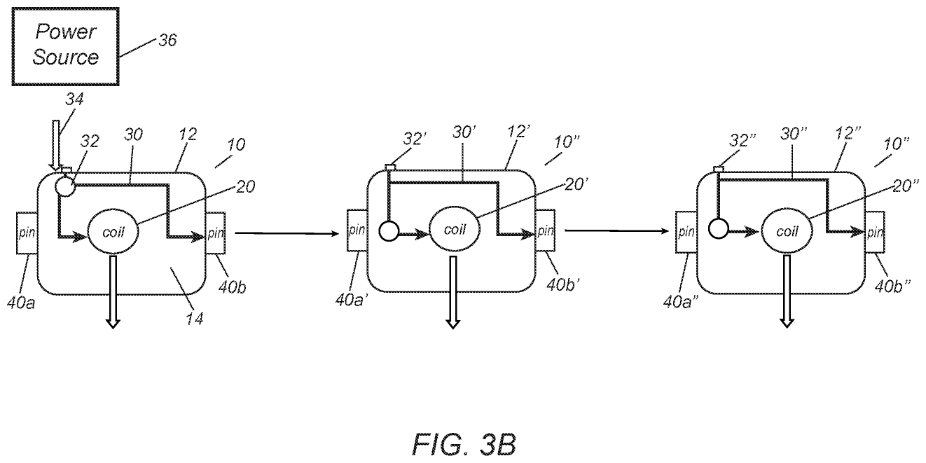

Turning to the drawings, FIGS. 1-3 show an exemplary embodiment of an inductive charging device or charger 10 that generally includes a housing 12 including an upper surface 14 upon which an electronic device may be placed (not shown), a plurality of side surfaces 16a-16d, and a lower surface 18 such that the housing 12 contains one or more electrical components, e.g., an inductive charging circuit 20 and a power distribution circuit 30, as shown in FIG. 3B. The device 10 also includes a plurality of connectors mounted to one or more of the side surfaces 16a-16d, for example, a power connector 32 for connecting a power cable 34 to the device 10, e.g., a USB-C port or other connector 32 to connect the device 10 to a power source 36, and one or more pin connectors 40 for connecting additional charging devices together, as described further elsewhere herein.

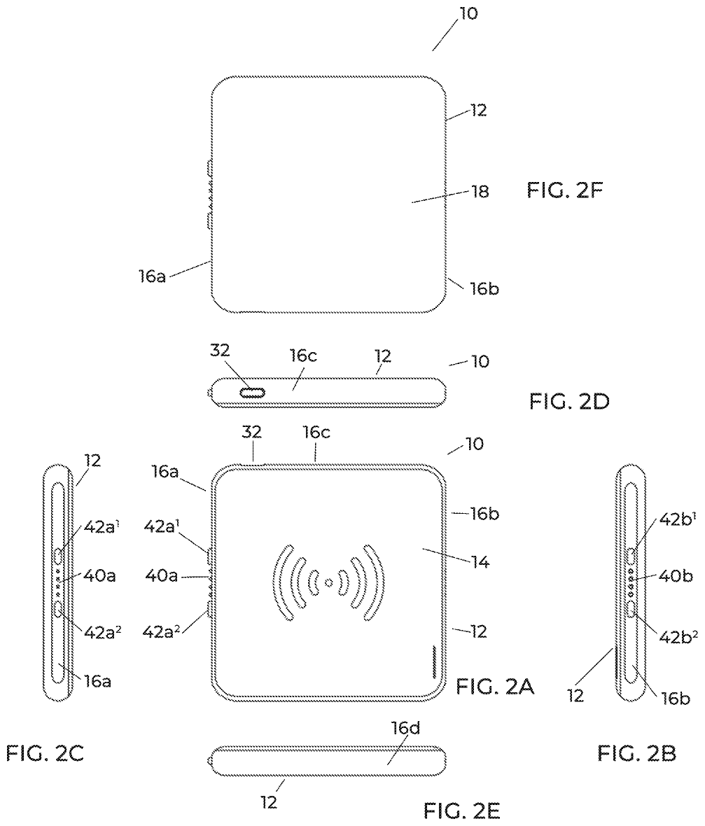

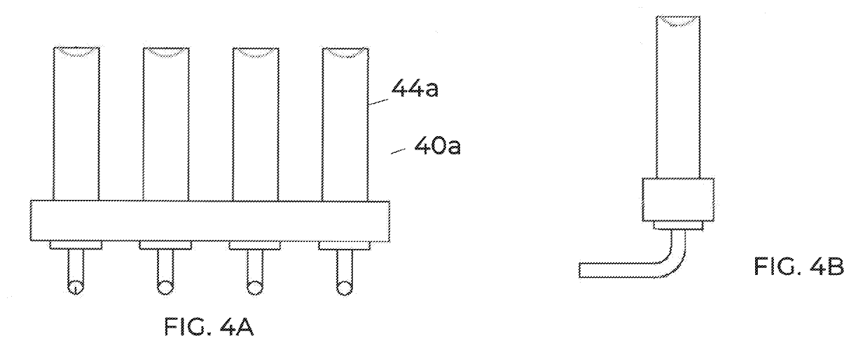

In the example shown in FIGS. 1 and 2, the device 10 includes a first female pin connector 40a on a first side surface 16a and a second male pin connector 40b on a second side surface 16b, e.g., opposite the first side surface 16a. Exemplary embodiments of pin connectors 40a, 40b are shown in FIGS. 4A-5B that may be mounted to or otherwise provided on the housing 12. As shown in FIGS. 4A and 4B, a female pin connector 40a may include four pin tubes 44a in a linear arrangement that may be mounted to first side surface 16a such that the pin tubes 44a are aligned parallel to the upper surface 14 of the housing 12, e.g., midway between opposite corners of the first side surface 16a. In FIGS. 5A and 5B, a corresponding male connector 40b includes four pin tubes 44b arranged in a similar linear arrangement, and a plurality of pin needles 46b that are biased to extend out from the tubes 44b, but may be at least partially retracted into the tubes 44b. The pin needles 46b are sized such that they may be received in corresponding tubes 44a of the female connector to electrically couple the pin connectors on different charging devices, as described further elsewhere herein. It will be appreciated that other male/female connectors or mating connectors may be provided on the charging devices herein to allow them to be coupled together.

Returning to FIGS. 1 and 2, the device 10 also includes one or more magnet arrays 42, e.g., on side surfaces including pin connectors 40. For example, as shown in FIG. 2B, the first side surface 16a includes a first magnet array 42a including two magnets 42a1, 42a2 mounted to the housing 12 on either side of the connector 40a. Similarly, as shown in FIG. 2C, the second side surface 16b includes a second magnet array 42b including two magnets 42b1, 42b2 mounted to the housing 12 on either side of the connector 40b.

The first magnet array 42a is configured to attract a magnet array from a second charging device having a compatible connector such that the compatible connector is automatically coupled to the first connector 42a when the second charging device is positioned adjacent the first side surface. Conversely, the first magnet array 42a is configured to repel a magnet array from a second charging device having an incompatible connector such that the incompatible connector cannot be coupled to the first connector 42a when the second charging device is positioned adjacent the first side surface.

For example, in the example where the first connector 40a is female, the magnets 42a1, 42a2 of the first magnet array 42a may have their polarities arranged to attract the magnet array of a male connector and repel a female connector. Similarly, where the second connector 40b is male, the magnets 42b1, 42b2 of the second magnet array 42b may have their polarities arranged to attract the magnet array of a female connector and repel a male connector. In an exemplary configuration, to achieve this desired attraction/repelling, the female connector 40a may include magnets 42a1, 42a2 mounted to the housing 12 such that their north poles are oriented outwardly from the first side surface 16a, and the male connector 40b may include magnets 42b1, 42b2 mounted to the housing 12 such that their south poles are oriented outwardly from the second side surface 16b. Thus, the magnet arrays of male connectors may attract magnet arrays of female connectors and repel male connectors. It will be appreciated that the magnet arrays may include any number of magnet elements and/or pole arrangements on the corresponding side surfaces to preferentially attract compatible connectors and repel incompatible connectors.

The magnets for the magnet arrays 42a, 42b may be mounted to the housing 12 in a variety of ways. For example, the magnets may be substantially permanently mounted to an inside of the corresponding side surfaces, e.g., by one or more of bonding with adhesive, sonic welding, fusing, interference fit within a recess in the side surfaces, and the like. Alternatively, the magnets may be molded, cast, or otherwise integrated into the material of the side surfaces of the housing 12. In exemplary embodiments, the magnets may be disc magnets, bar magnets, and the like such that the magnets may be mounted adjacent the side surfaces to provide the desired polarities to attract and repel the corresponding compatible and incompatible connectors, respectively.

With further reference to FIG. 3B, the device 10 may include one or more rigid or flexible printed circuit boards and/or other components within the housing 12 to provide the internal electrical components for the device. For example, as shown, an inductive charging circuit 20 may be provided within the housing 12 similar to conventional inductive chargers, e.g., including one or more of a coil acting as a transmitter of electrical energy, a microcontroller or other oscillator configured to generate a resonant frequency to the coil, a power transistor or other amplifier for driving the coil, and the like (not shown). Examples of such circuits may be found in U.S. Pat. Nos. 8,890,369, 9,143,041, 10,355,532, and 10,424,962, the entire disclosures of which are expressly incorporated by reference herein.

In addition, a power distribution circuit 30 may be provided within the housing 12 for distributing electrical energy from a power source to the various components, e.g., coupling the power connector 32, the inductive charging circuit 20, the first connector 40a, and the second connector 40b in parallel to simultaneously provide electrical energy, e.g., when a power cable 34 is connected to the power connector 32 and a power source 36 or the device 10 is connected to another charging device already connected to a power source (not shown).

For example, the power connector 32 may be a Type-c USB input connector to which a power cable 34 may be connected. The power cable 34 may, in turn, be coupled to an electrical outlet, a battery, or other power source. For example, the power cable 34 may include a Type-c USB connector on a first end (for connecting to the power connector 32) and one of a two or three-prong A/C connector for connecting to an electrical outlet, a USB connector, and the like on a second end (not shown), as are known in the art. Alternatively, a power cable may be permanently connected to the device (not shown), which may include a second connector for connecting to a power source.

In addition, when another charging device is connected to one of the pin connectors 40a, 40b that is itself connected to a power source, the power distribution circuit 30 may be configured to deliver electrical energy simultaneously to the other pin connector 40b, 40a and the inductive charging circuit 20, e.g. connected in parallel with one another, as described further elsewhere herein.

For example, as shown in FIGS. 3A and 3B, a first charging device 10 is shown connected to a power source 36, e.g., an electrical outlet, battery, computer, and the like (not shown), via a cable 34 plugged into the power connector 32. Consequently, electrical energy from the power source 36 may be delivered to the inductive charging circuit 20 and the pin connectors 40a, 40b to provide energy as needed. For example, if an electrical device, e.g., a cellphone, tablet, wireless headphone, watch, GPS device, and the like (not shown), is placed on the upper surface 14 of the housing 12, the inductive charging circuit 20 may automatically deliver energy inductively to the electrical device to recharge its battery.

If, as also shown in FIGS. 3A and 3B, a second charging device 10′ is coupled to the second pin connector 40b of the first device 10 via a third pin connector 40a′, the power distribution circuit 30′ of the second charging device 10′ may deliver electrical energy to its inductive charging circuit 20′ such that a second electrical device placed on its upper surface may also be recharged simultaneously, as well as to a fourth pin connector 40b′. Furthermore, if a third charging device 10″ is coupled to the fourth pin connector 40b′ via fifth pin connector 40a″, the power distribution circuit 30″ of the third charging device 10″ may deliver electrical energy to its inductive charging circuit 20″ such that a third electrical device placed on its upper surface may also be recharged simultaneously (as well as to a sixth pin connector 40b″).

Thus, in the configuration shown, multiple charging devices similar to device 10 may be connected to one another in a linear arrangement given pin connectors 40 on opposite side surfaces of each device 10 with power from the power source 36 carried in parallel to the connectors and charging circuits. The magnet array 42 adjacent to each pin connector may ensure that a compatible pin connector is connected to the charging devices, e.g., by automatically attracting and connecting a female pin connector 40a′ of the second device 10′ to male pin connector 40b of the first device 10 (or vice versa), and preventing a male connector 40b′ of the second device 10′ from being connected to the male pin connector 40b of the first device 10 (or two female connectors from being connected together.

In the example shown in FIG. 3B, the first charging device 10 is connected to the power source 36 and two additional charging devices 10′, 10″ are connected, in essence, in parallel with the first charging device 10 to receive power from the power source 36 via the power distribution circuits 30, 30′, 30″. Thus, in essence, the connector 40b is the power output port and connector 40a′ is the power input port for the second charging device 10′ and the connector 40b′ is the power output port and connector 40a″ is the power input port for the third charging device 10.” Alternatively, the power source may be connected to power connectors on the second or third devices, as desired and the system will operate essentially the same. Optionally, additional charging devices may be coupled to pin connector 40a of the first device 10 and/or the pin connector 40b″ of the third device 10″ up to a desired limit in the number of charging devices.

Once the desired number of charging devices, e.g., 10-10″, are connected together, an electronic device (not shown) may be placed on each of the charging devices 10-10″ to charge them simultaneously. It will be appreciated that any combination of inductively chargeable devices may be placed on the resulting set of coupled charging devices, e.g., any combination of one or more cellphones, tablets, wireless headphones, watches, GPS devices, and the like. For example, a user can connect three chargers together and then place a cellular phone, watch, and headphones on separate chargers to charge them simultaneously.

Optionally, in an alternative embodiment, additional connectors may be provided on the charging devices herein, e.g., by adding male and/or female pin connectors (not shown) to one or both of the third and fourth side surfaces 16c, 16d of the device 10 shown in FIGS. 2A-2F. The power distribution circuit may then be configured to deliver power simultaneously to each of the connectors (and the charging circuit), e.g., in parallel. In this alternative, the power connector may be moved to a location to avoid interference with connecting multiple charging devices together, e.g., to the lower surface 18, corners, or elsewhere (not shown).

Further optionally, one or more additional features may be provided on one or more of the charging devices described herein. For example, a battery or other power bank (not shown) may be provided within the charger 10 such that the battery/power bank is charged when the charging device (or a connected charging device) is connected to a power source. Subsequently, the battery/power bank could be used as a power source to provide power to the charger (and, optionally, other connected chargers) to charge electronic devices placed on the chargers when they are not connected to an external power source.

In another option, the charging device 10 may include a stand, e.g., to orient the housing 12 diagonally, vertically, or in other desired positions. In still another option, the charging device 10 may include one or more additional features, e.g., a docking station for connecting other devices to the charger. In another option, a magnet or other retention device (not shown) may be provided within the housing 12, e.g., beneath the upper surface 14 that may retain a portable electronic device placed on the upper surface 14 for charging. For example, the portable electronic device may include a corresponding magnet or ferromagnetic structure that may be attracted to a magnet beneath or within the upper surface 14 to hold the device against the upper surface 14 during charging, whereupon the user may remove the device simply by overcoming the attraction force.

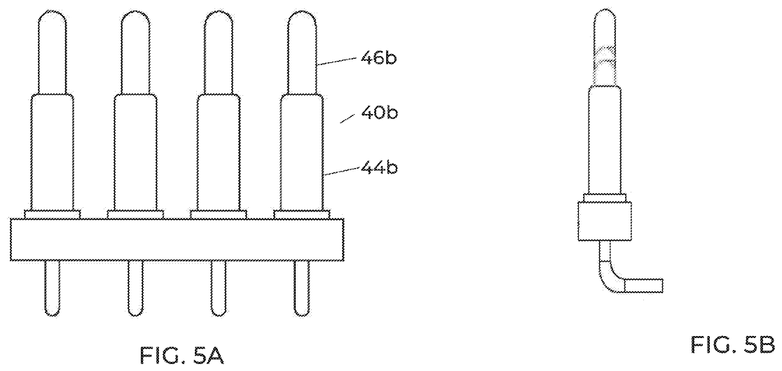

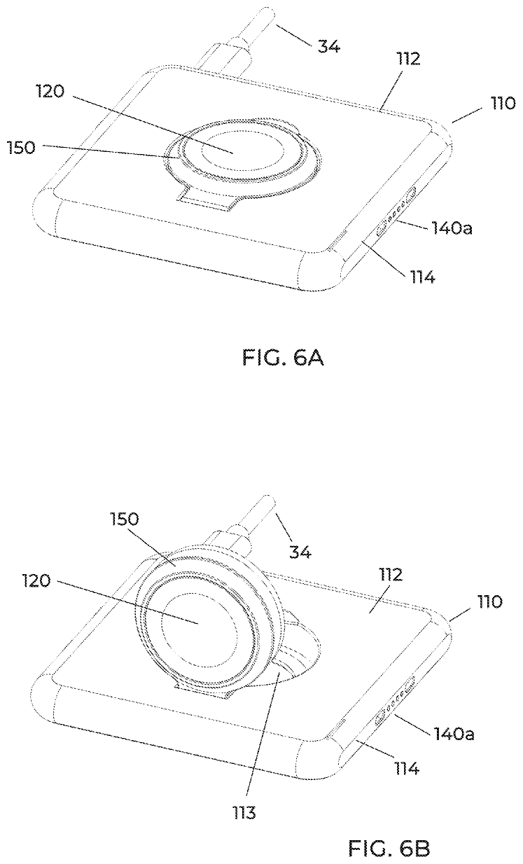

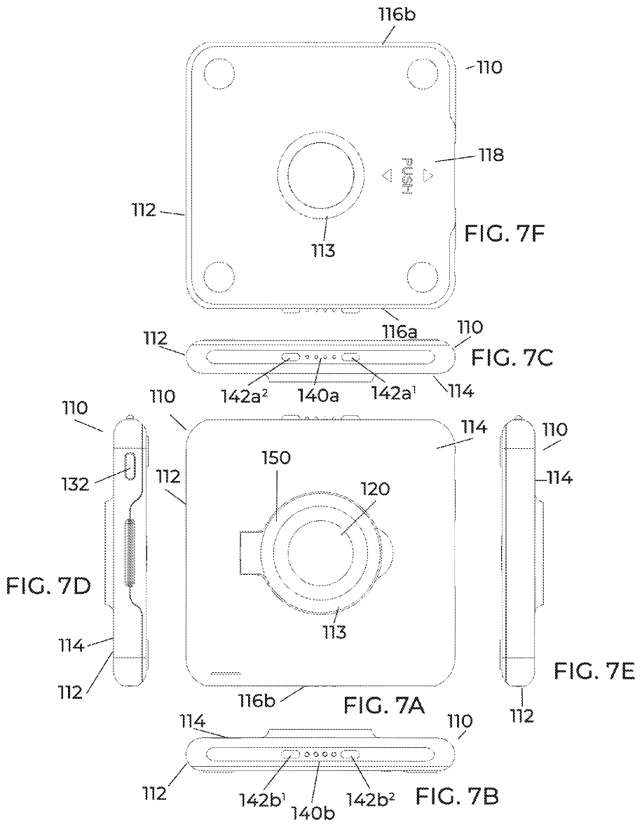

Turning to FIGS. 6A-7F, another example of an inductive charging device or charger 110 is shown that includes a housing 112 including an upper surface 114 upon which a portable electronic device (not shown) may be placed, a plurality of side surfaces 116a-116d, and a lower surface 118, and includes one or more electrical components, e.g., an inductive charging circuit or charger 120 and a power distribution circuit (not shown), e.g., similar to other embodiments described elsewhere herein. The device 110 also includes a plurality of connectors mounted to one or more of the side surfaces 116a-116d, for example, a port or other power connector 132 for connecting a power cable 34 to the device 110, and one or more pin connectors 140 for connecting additional charging devices together, also similar to other embodiments herein.

In addition, the device 110 includes a charging mount 150 that carries the inductive charger 120 and is movably coupled to the housing 112. For example, the housing 112 may include an opening or recess 113, e.g., extending entirely through the housing 112 from the upper surface 114 to the lower surface 118 (or alternatively, only partially from the upper surface 114 into the housing 112). The mount 150 may be pivotally coupled to the housing 112, e.g., by one or more hinges and the like (not shown), such that the mount 150 may be moved from a flat or recessed position, e.g., with the inductive charger 120 seated within the opening 113, as shown in FIG. 6A, to a raised position where the inductive charger 120 is positioned substantially vertically or laterally above the upper surface, as shown in FIG. 6B. For example, as labeled in FIG. 6F, the user may simply “push” the mount 150 from the bottom surface 118 to direct the mount 150 from the flat position to the raised position. Optionally, the mount 150 and/or housing 112 may include a locking mechanism, e.g., cooperating detents, frictional engagement features, and the like (not shown) that may engage to secure the mount 150 in the raised position. The locking mechanism may include a release or the mount 150 may simply be directed back to the flat position by overcoming the resistance of the locking mechanism. Such a raised position may facilitate placing a portable electronic device, e.g., a wristband of an Apple Watch or similar device (not shown) around the mount 150 to charge the device using the inductive charger 120.

The inductive charger 120 may be electrically coupled to the power distribution circuit within the housing 112, e.g., to draw current from a power source connected to the connector 132 and/or from another charger device connected to one of the pin connectors 140 to charge a device positioned adjacent the inductive charger 120, similar to other embodiments herein. In one embodiment, the inductive charger 120 may be a standard inductive charger, e.g., a MFI certified charging cable provided with an electronic device including a receiver on a first end (e.g., including a coil and/or other components necessary to inductively charge the device), and a USB or other connector on a second opposite end. The mount 150 may include a recess or opening sized to hold the receiver end, e.g., inserted into the mount 150 when in the raised position to provide the charger 120, and the housing 112 may include a connector (not shown) within the recess 113 configured to connect to the second end. This connector may be coupled to the power distribution circuit of the device 110 such that the inductive charger may be inserted into the mount 150 and connected to the connector to then charge the electronic device, yet may be removable from the device 110, if desired. Optionally, the receiver may include one or more magnets or other retention devices (not shown) for removably securing the electronic device to the charger and mount 150 during charging.

The charging device 110 shown in FIGS. 6A-7F may be used in conjunction with one or more similar to devices and/or with one or more of the other charging devices described elsewhere herein. For example, with reference to FIG. 3A, the charging device 110 may be used in place of any of the devices 10-10″ to charge multiple electronic devices simultaneously. Any one of the devices may be coupled to a power source and thereby provide power to each of the charging circuits via the parallel arrangement of the power distribution circuits coupled to the connectors, as described elsewhere herein.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the scope of the appended claims.

1. A device for charging electronic devices, comprising:
a housing including an upper surface upon which an electronic device may be placed, and a plurality of side surfaces;
an inductive charging circuit within the housing adjacent the upper surface for inductively charging an electronic device placed on the upper surface;
a power connector on the housing for connecting to a power cable to connect the power connector to a power source;
a first connector and a first magnet array on a first side surface of the plurality of side surfaces; and
a power distribution circuit within the housing coupling the power connector to the inductive charging circuit and the first connector to simultaneously provide electrical energy to the inductive charging circuit and the first connector when a power cable is connected to the power connector and the power source,
wherein the first magnet array is configured to attract a magnet array from a second charging device having a compatible connector such that the compatible connector is automatically coupled to the first connector when the second charging device is positioned adjacent the first side surface.

2. The device of claim 1, wherein the first magnet array is configured to repel a magnet array from a second charging device having an incompatible connector such that the incompatible connector cannot be coupled to the first connector when the second charging device is positioned adjacent the first side surface.

3. The device of claim 1, wherein the first magnet array comprises a plurality of magnetic elements adjacent the first side surface.

4. The device of claim 3, wherein the plurality of magnetic elements are mounted to the housing adjacent the first connector.

5. The device of claim 3, wherein the first side surface extends between first and second corners of the housing, the first connector is mounted to the first side surface between the first and second corners, and the plurality of magnetic elements comprise a first magnetic element mounted to the first side surface between the first connector and the first corner and a second magnetic element mounted to the first side surface between the first connector and the second corner.

6. The device of claim 5, wherein the first and second magnetic elements have opposite polarities.

7. The device of claim 5, wherein the first and second magnetic elements have the same polarity.

8. The device of claim 1, wherein the first connector is a male connector and wherein the compatible connector is a female connector.

9. The device of claim 1, wherein the first connector is a female connector and wherein the compatible connector is a male connector.

10. The device of claim 1, further comprising a second connector and a second magnet array on a second side surface of the plurality of side surfaces, the power distribution circuit coupled to the second connector to simultaneously provide electrical energy to the second connector as well as the inductive charging circuit and the first connector.

11. The device of claim 10, wherein the second side surface is on an opposite side of the housing from the first side surface.

12. The device of claim 10, wherein one of the first and second connectors is a male connector and the other of the first and second connectors is a corresponding female connector.

13. The device of claim 12, wherein the first magnet array and the second magnet array have complementary polarity arrangements to attract a corresponding connector from another charging device.

14-22. (canceled)

23. The device of claim 1, wherein the inductive charging circuit is carried on a mount received in a recess in the housing, and wherein the mount is movable out of the recess to a raised position to position the inductive charging circuit laterally relative to the upper surface of the housing.

24. The device of claim 23, wherein the mount is pivotally coupled to the housing by one or more hinge elements.

25. The device of claim 23, wherein the recess extends from the upper surface to the lower surface such that the mount may be moved towards the raised position by pushing on the mount from the lower surface.

26. The device of claim 23, wherein the inductive charging circuit comprises a receiver removably coupled to the mount, the receiver including an inductive charging coil.

27. The device of claim 26, further comprising a cable extending from the receiver to a receiver connector, the receiver connector connected to a corresponding connector on the housing adjacent the recess to connect the receiver to the power distribution circuit.

28-36. (canceled)

37. A system including a plurality of modular charging devices for simultaneously charging multiple electronic devices, each charging device comprising:
a housing including an upper surface upon which an electronic device may be placed, and a plurality of side surfaces;
an inductive charging circuit for inductively charging an electronic device placed on the upper surface;
a first male connector and a first magnet array on a first side surface of the plurality of side surfaces;
a second female connector and a second magnet array on a second side surface of the plurality of side surfaces; and
a power distribution circuit within the housing to distribute electrical energy in parallel to the inductive charging circuit, the first male connector, and the second female connector,
wherein at least one of the charging devices comprises a power connector or power cable for connecting to a power source, and
wherein the first and second magnetic arrays are configured to attract male and female connectors of adjacent charging devices to automatically connect adjacent male and female connectors such that the power distribution circuits simultaneously deliver electrical energy from the power source to each inductive charging circuit to simultaneously charge electronic devices placed on each charging device.

38-40. (canceled)

41. A method for simultaneously charging multiple electronic devices, comprising:
connecting a first charging device to a power source, the first charging device including a first connector on a first side surface and a first inductive charging circuit coupled to the power source via a power circuit of the first charging device, the first charging device further comprising a first magnet array on the first side surface adjacent the first connector;
placing a second charging device adjacent the first side surface, the second charging device including a second connector on a second side surface coupled to a second inductive charging circuit, the second charging device further comprising a second magnet array on the second side surface adjacent the second connector; and
orienting the second side surface towards the first side surface such that,
a) if the first and second connectors are compatible, the first and second magnet arrays attract one another to automatically connect the second connector to the first connector to deliver electrical energy from the power source to the second inductive charging circuit, and
b) if the first and second connectors are incompatible, the first and second magnet arrays repel one another to prevent connecting the second connector to the first connector.
